(19) United States
(12) Patent Application Publication
(10) Pub. No.: US 2019/0188057 A1
(43) Pub. Date: Jun. 20, 2019

(54) System and Method to Measure the Response Time of Event Chains

(71) Applicants: Robert Bosch GmbH, Stuttgart (DE); Robert Bosch Engineering and Business Solutions Private Limited, Bangalore (IN)

(72) Inventors: Christian Heissenberger, Neuhausen (DE); Adarsha Korlagundi Shridhara, Bangalore (IN); Kattula Ramanjaneyulu, Bangalore (IN)

(21) Appl. No.: 16/222,432

(22) Filed: Dec. 17, 2018

(30) Foreign Application Priority Data
Dec. 18, 2017 (IN) 201741045396

(51) Int. Cl. G06F 9/54; G06F 11/34; G06F 11/30

(52) U.S. Cl. CPC G06F 9/542; G06F 11/3024; G06F 11/3409

(57) ABSTRACT

A method to measure response time of a chain of events that is a set of individual events includes identifying a chain of events comprising a set of events for which the response time is to be measured; identifying a sequence for processing of said events; tracking the processing of each of the identified events in said sequence; waiting until all the identified events are executed in said sequence; and calculating response time of said chain of events by marking beginning of execution of first event and the end of execution of last event, after making sure that each of said events is considered executed only when the preceding event in said sequence is executed.

### FIELD OF THE INVENTION

This invention relates to a measurement system for measuring processing time of a set of events. The set of events have a pre-defined sequence for processing.

### BACKGROUND OF THE INVENTION

Response time is an important characteristic of a real time embedded system like electronic control units (ECU) used in vehicles. The timing behavior of the system needs to be measured and understood. In the ECU, the response time is influenced by HW and SW delays.

The US patent application 2004/0039935 A1 discloses one method for measuring the run time of a task in a real-time system having a number of tasks. The method disclosed in the prior art provides that the timer is started at the beginning of the task whose run time is to be determined, and the timer is stopped in response to an interrupt, the timer status is stored, and, following termination of the interrupt, the timer is started again. The device according to the prior art provides one timer for measuring run time for different tasks.

A description/definition of “event-chains” is described here . . . .

### BRIEF DESCRIPTION OF THE ACCOMPANYING DRAWINGS

An embodiment of the disclosure is described with reference to the following accompanying drawing,

FIG. 1 shows a flow diagram of different tasks being executed

FIG. 2 shows a flow diagram of different tasks being considered for response time measurement

FIG. 3 shows a flow diagram of different tasks being considered for response time measurement, the tasks being run on different cores of a controller.

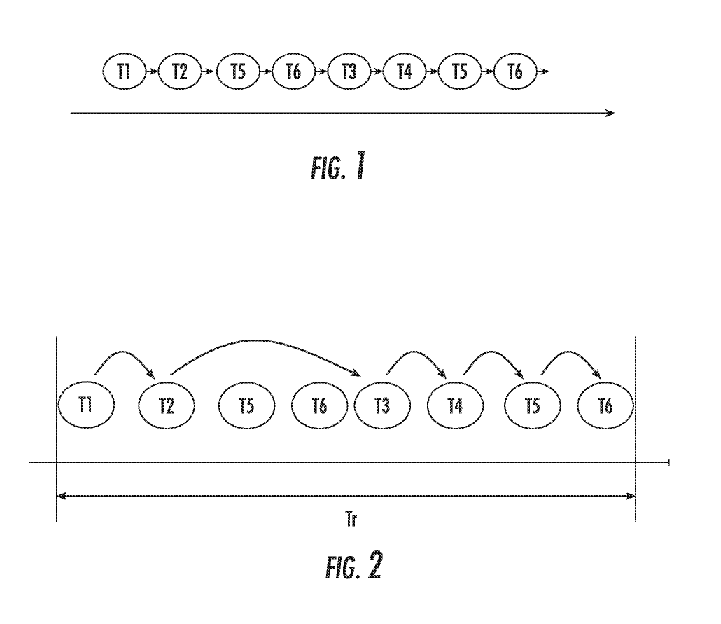

### DETAILED DESCRIPTION OF THE EMBODIMENTS

Shown in FIG. 1 is a flow of different events being executed in the order of time of execution. This flow is one of the use cases and the sequence of event execution may vary depending upon the input received.

Here the tasks are referred to a set of instructions executed by the controller. The controller typically comprises a processing unit, input interfaces, output interfaces and memory. The input interfaces may receive inputs from various sensors. The output interfaces may be further connected to various actuators.

The measurement system consists of a debugger HW, a measurement SW and the associated event chain information. The response time measurement system is established on a laptop or any other data processing unit. The response time measurement system is loaded with the details of the event chain. The individual event in the chain is tracked as and when it is executed dynamically on the ECU HW. In one embodiment, the events may run in HW debugger environment. In another embodiment, the events may run in the actual ECU.

a In this document, the terms like tasks, processes, events and functions may be used interchangeably. The terms like response time, processing time and execution time may be used interchangeably. The terms like “response time measurement system”, “measurement system” or “system” may refer to same system. “Event” refers to individual event and “event-chain” refers to a set of events. Also the terms “controller” and “processor” may be used interchangeably.

Event may be defined as abstract representation of a specific system behavior which can be observed at runtime. Event chain may be defined as the specification of a causal order in the sequence of timing event occurrences at runtime. By means of an event chain the correlation between a stimulation of a system and its corresponding response can be explicitly described.

The measurement method includes tracking the execution of events. The events may be running on different cores of one processor or same core. To measure the response time of an event chain, the events should run in a specified order as in the description/specification of the event chain, starting from the beginning of the first event till end of execution of last event.

For example, when the driver presses the accelerator pedal, how fast the engine responds by generating higher torque, is the response time of the engine control system. This response time may depend upon various functions which get executed when the accelerator pedal is pressed.

These functions may be distributed in different processors or in different cores of the processor or may be running in same core of one processor. The response time may be also referred as processing time or execution time.

Event-chains are a series of events happening in the ECU during SW execution. Statically they can be visualized as a chain of processes/functions executed sequentially by the ECU. The total response time of the system is a sum of response time of many event chains. For every input, there may be various events to be executed. These events are organized in different tasks run by the controllers. As per Autosar, event-chains are described as Stimulus-response relationship between events.

To measure the response time for an input (stimulus), there may be various events to be executed before the final response is obtained. To determine the response time between the input stimulus event occurrence and the expected result (response event), the execution of individual events is to be tracked and after the last event is executed, the response time is calculated as the time taken from beginning of execution of first event and the end of execution of last event, the events being executed in defined sequence.

Typically a measurement system is used to measure the response time. The measurement system is connected to the ECU over a communication interface, for example CAN bus. The software which is to be run in the ECU comprises of various tasks. These tasks may be executed by an operating system at different intervals or based on inputs. It is also possible that these functions may be executed using interrupts or may be directly called by other functions. According to the invention, the tasks in the ECU are inserted with monitoring/measurement programs. These monitoring programs keep track of which events are executed.

In the measurement system, the user can select which events are to be monitored for measuring the response times. The list of tasks is created. The user can also input the sequence of the tasks to be executed. It is to be observed that some tasks may get executed more often than other tasks based on the scheduling frequency by the operating system. The measurement system communicates the list of tasks and the order of execution to ECU. The ECU monitors the execution of selected events and time stamps each event. This information is passed on to the measurement system at regular intervals or based on events. Once all the tasks are executed in the identified sequence, the measurement system computes the response time and displays. It is also possible that the ECU computes the response time for the chain of events and communicates the same to the measurement system. The ECU keeps track of the executed events even though they are running on same or different cores of processors.

The working of the measurement system is explained below with an example.

Assume there are T1 to T10 tasks in the ECU. The user wants to measure the response time for an event E1 which will result in execution of the tasks T1, T2, T3, T4, T5 and T6. The user selects these tasks and also assigns the order of execution of the tasks. The order in this case may be T1, T2, T3, T4, T5 and T6. This is referred as sequence of tasks or chain of events.

Here T1 to T6 are referred as chain of events. The user wants to measure the response time for this chain of events, i.e. the time taken from beginning of execution of T1 till end of execution of T6.

The measuring system communicates to the ECU about the list of tasks to be monitored for response time measurement. The measuring system also communicates the sequence of tasks to the ECU

In one embodiment the ECU marks the tasks to be monitored and the sequence selected by the user. The ECU may include monitoring programs in the tasks for starting and stopping/freezing a timer to measure the time taken by a task. Once the event chain is completed, the total response time is communicated to the measurement system

In another embodiment, the measurement system may make the changes in the tasks and the modified tasks are sent to ECU. The ECU stores these modified tasks and monitors them to see when the chain of event completes.

Assume that the ECU runs T1, then T2, then T5, then T6, then T3, then T4, then T5 and then T6 as shown in FIG. 1a. This shows the actual execution sequence by ECU.

It is observed that, in the above scenario, the tasks T5 and T6 are run twice I the event chain, as these may be scheduled more often than other tasks by the operating system.

The arrows and the tasks in FIG. 1b shows the sequence selected by the user. Hence the response time for the chain of events is the beginning of T1 till end of T6.

It should be observed that when user selected the sequence, each task is considered complete only when the previous task was executed. In the above scenario, the task T5 is considered completed only after T4 was executed. If T5 runs ahead of T4, then T5 is not regarded as completed (only for timing measurement purpose). Similarly T6 is considered to be completed only if the previous task T5 was executed. Thus the task T5 and T6 which run before the tasks T3 and T4 are not considered as completed. Hence ECU considers the event chain to be complete only when the above pre-requisites are met.

Thus the ECU waits for the sequence of tasks to be completed before computing the response time taken for the chain of events. The response time is shown as Tr in FIG. 1b.

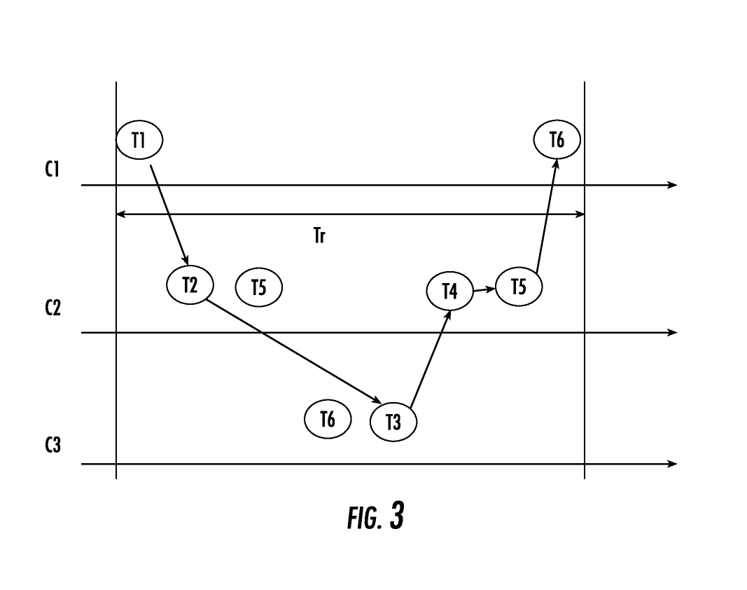

FIG. 3 shows similar scenario where different tasks are run on different cores of a processor. Here C1, C2 and C3 represent different cores of the processor. The Tasks T1 and T6 run on core 1. The tasks T2, T4 and T5 run on core 2. The task T3 runs on core 3. Here too even though the tasks T5 and T6 run ahead of T4 and T5, the tasks T5 and T6 are not considered as complete for the measurement purpose. The chain of events is considered as complete only when individual tasks run after their predecessor task runs. The response time is computed only when all the tasks run and when each task runs only after the preceding task is run.

The measurement system may have integrated development environment to develop/modify/compile and download the code to be run in the ECU.

In one embodiment the measurement system may be a standalone system connectable to the ECU. In another embodiment, the measurement system may be remotely connected to the ECU.

A measurement system typically comprises: an interface to communicate with electronic control unit; an identification module to identify a set of events and their sequence of processing in ECU; an instrumentation module to insert measurement programs in the ECU to identify processing of said events; a tracking module running on said system to track processing of events in said ECU; a measurement module to measure response time of chain of events by computing the time from beginning of execution of first event till end of execution of last event in selected sequence while making sure that each of said events is considered executed only when the preceding event in sequence is executed.

Here the interface between the measurement system and the ECU may be through a bus or through Ethernet, or Jtag interface. The identification module refers to a set of instructions which will different events occurring. The tracking module may be a set of instructions which keep track of execution of tasks or events. The measurement module may be a set of instructions to compile the response time by receiving various information from ECU. It is also possible that the measurement module receives the compiled response time from the ECU and displays it for the user.

Thus the method according to the invention provides an efficient way of computing response time for a chain of events. The method proposed is more accurate as the tasks are considered to be complete only when the preceding task in the sequence is run. Once all the tasks are run completely, the response time for the chain of events is computed.

We claim:

1. A method to measure response time of a chain of events, said method comprising the steps:
identifying a chain of events comprising a set of events (T1 to T6) for which the response time is to be measured
identifying a sequence for processing of said events
tracking the processing of each of the identified events in said sequence
waiting till all the identified events are executed in said sequence
calculating response time of said chain of events by marking beginning of execution of first event and the end of execution of last event, after making sure that each of said events is considered executed only when the preceding event in said sequence is executed

2. A method to measure processing time of a chain of events according to claim 1 wherein said events are real time events

3. A method to measure processing time of a chain of events according to claim 1 wherein said events are tracked and recorded as completed only when the events are processed in said identified sequence

4. A method to measure processing time of a chain of events according to claim 1 wherein processing time of an event is stored when the event is complete

5. A method to measure processing time of a chain of events according to claim 1 wherein said event is tracked and recorded as processed only when the preceding event in said identified sequence is processed

6. A method to measure processing time of a chain of events according to claim 1 wherein said events may be running on different cores of a processor.

7. A method to measure processing time of a chain of events according to claim 1 wherein said events may be running on same core of a processor.

8. A method to measure processing time of a chain of events according to claim 1 wherein said event is treated as not processed if the preceding event is not processed in said identified sequence

9. A method to measure processing time of a chain of events according to claim 1 wherein once all the events are recorded as processed, the response time is computed.

10. A method to measure processing time of a chain of events according to claim 1 wherein said response time is the duration of the time from beginning of execution of first event till end of execution of last event in said sequence.
the measurement system can repeat the measurement several times and compute the average, max and min response time of the event chain

11. A measurement system to measure response time of a chain of events, said events being run in an electronic control unit, said system comprising:
an interface to communicate with said electronic control unit ECU
an identification module to identify a set of events and their sequence of processing in said ECU
an instrumentation module to insert measurement programs in said ECU to identify processing of said events
a tracking module running on said measurement system to track processing of events in said ECU
a measurement module to measure response time of chain of events by computing the time from beginning of execution of first event till end of execution of last event in said sequence while making sure that each of said events is considered executed only when the preceding event in said sequence is executed
